(19) United States
(12) Patent Application Publication
(10) Pub. No.: US 2025/0391357 A1
(43) Pub. Date: Dec. 25, 2025

(54) PIXEL, DISPLAY DEVICE AND ELECTRONIC DEVICE HAVING THE SAME

(71) Applicant: Samsung Display Co., LTD., Yongin-si (KR)

(72) Inventors: Dong Han KIM, Yongin-si (KR); Hyung Gi JUNG, Yongin-si (KR); A Ram SEO, Yongin-si (KR); Soon Chang YEON, Yongin-si (KR); Se An YEOM, Yongin-si (KR)

(21) Appl. No.: 19/074,909

(22) Filed: Mar. 10, 2025

(30) Foreign Application Priority Data
Jun. 19, 2024 (KR) 10-2024-0079837
Sep. 6, 2024 (KR) 10-2024-0121577

(51) Int. Cl. G09G 3/3233; G09G 3/20

(52) U.S. Cl. CPC G09G 3/3233; G09G 3/2092; G09G 2300/0819; G09G 2300/0842; G09G 2310/08; G09G 2320/0257; G09G 2330/02

(57) ABSTRACT

A pixel includes: a driving transistor including a gate electrode connected to a first node, and connected between a first power voltage and a second node; a light-emitting element connected between the second node and a second power voltage; a first switching transistor including a gate electrode connected to a scan line, and connected between a data line and the first node; a second switching transistor including a gate electrode connected to a sensing scan line, and connected between a readout line and the second node; and a third switching transistor including a gate electrode connected to an initialization scan line, and connected between an initialization line and the second node. During a first period, the second switching transistor is turned on, and during a second period different from the first period, the third switching transistor is turned on.

This application claims priority to Korean Patent Application No. 10-2024-0079837, filed in on Jun. 19, 2024, and Korean Paten Application No. 10-2024-0121577, filed on Sep. 6, 2024, and all the benefits accruing therefrom under 35 U.S.C. § 119, the contents of which in their entireties are herein incorporated by reference.

### BACKGROUND

### 1. Field

Embodiments of the invention relate to a pixel, a display device including the pixel, and an electronic device including the display device.

### 2. Description of the Related Art

With the advancement of information technology, the importance of display devices as a medium for providing information to users has been emphasized. Accordingly, display devices such as liquid crystal display devices and organic light-emitting display devices are widely used in various fields.

A display device typically includes a plurality of pixels connected to data lines, scan lines, and sensing scan lines. A pixel may include a pixel circuit and a light-emitting element, and the light-emitting element emits light at a predetermined luminance in response to a driving current supplied from a driving transistor via the pixel circuit.

### SUMMARY

Embodiments of the invention provide a pixel, a display device including the pixel, and an electronic device including the display device that can alleviate ghosting effects, which may occur when changing the frame refresh rate.

A pixel according to an embodiment of the invention includes a driving transistor including a gate electrode connected to a first node, and connected between a first power voltage and a second node; a light-emitting element connected between the second node and a second power voltage; a first switching transistor including a gate electrode connected to a scan line, and connected between a data line and the first node; a second switching transistor including a gate electrode connected to a sensing scan line, and connected between a readout line, which supplies a third power voltage, and the second node; and a third switching transistor including a gate electrode connected to an initialization scan line, and connected between an initialization line, which supplies a fourth power voltage, and the second node. In such an embodiment, during a first period, the second switching transistor is turned on, and during a second period different from the first period, the third switching transistor is turned on.

In an embodiment, the pixel may further include a storage capacitor connected between the first node and the second node.

In an embodiment, during the first period, a charging operation may be performed for setting a gate-source voltage of the driving transistor, and during the second period, an initialization operation may be performed for initializing a voltage of the second node.

In an embodiment, during the first period, while the second switching transistor is turned on, the third switching transistor may be turned off, and during the second period, while the third switching transistor is turned on, the second switching transistor may be turned off.

In an embodiment, during the charging operation, the first switching transistor may be turned on.

In an embodiment, during the initialization operation, the first switching transistor may be turned off.

In an embodiment, a magnitude of the third power voltage may be the same as a magnitude of the fourth power voltage.

A display device according to another embodiment of the invention includes a display panel including a plurality of pixels; a scan driver connected to the display panel through a plurality of scan lines, a plurality of sensing scan lines, and a plurality of initialization scan lines; a data driver connected to the display panel through a plurality of data lines, a plurality of readout lines, and a plurality of initialization lines; and a timing controller which receives image data and controls the scan driver and the data driver to display an image corresponding to the image data. In such an embodiment, each of the plurality of pixels includes a driving transistor including a gate electrode connected to a first node therein and connected between a first power voltage and a second node therein; a light-emitting element connected between the second node and a second power voltage; a first switching transistor including a gate electrode connected to a corresponding one of the plurality of scan lines and connected between a corresponding one of the plurality of data lines and the first node; a second switching transistor including a gate electrode connected to a corresponding one of the plurality of sensing scan lines and connected between a corresponding one of the plurality of readout lines and the second node; and a third switching transistor including a gate electrode connected to a corresponding one of the plurality of initialization scan lines, which supplies a third power voltage, and connected between a corresponding one of the plurality of initialization lines, which supplies a fourth power voltage, and the second node. In such an embodiment, the second switching transistor is turned on during a first period, and the third switching transistor is turned on during a second period different from the first period.

In an embodiment, each of the plurality of pixels may further include a storage capacitor connected between the first node therein and the second node therein.

In an embodiment, during the first period, a charging operation for a pixel may be performed for setting the gate-source voltage of the driving transistor of the pixel, and during the second period, an initialization operation for the pixel may be performed for initializing the voltage of the second node in the pixel.

In an embodiment, during the first period, while the second switching transistor included in the pixel may be turned on, the third switching transistor included in the pixel is turned off, and during the second period, while the third switching transistor included in the pixel is turned on, the second switching transistor included in the pixel may be turned off.

In an embodiment, during the charging operation for the pixel, the first switching transistor of the pixel may be turned on.

In an embodiment, during the initialization operation for the pixel, the first switching transistor of the pixel may be turned off.

In an embodiment, a magnitude of the third power voltage may be the same as a magnitude of the fourth power voltage.

In an embodiment, the first pixel among the plurality of pixels may be connected to the first scan line among the plurality of scan lines, the first data line among the plurality of data lines, the first readout line among the plurality of readout lines, and the first initialization line among the plurality of initialization lines. In such an embodiment, the second pixel among the plurality of pixels may be connected to the second scan line among the plurality of scan lines, the first data line, the first readout line, and the first initialization line. In such an embodiment, during a charging operation of the first pixel, an initialization operation of the second pixel may be performed.

In an embodiment, during an application of the third power voltage to the first pixel through the first readout line, the fourth power voltage may be applied to the second pixel through the first initialization line.

An electronic device according to another embodiment of the invention includes a display panel including a plurality of pixels; a gate driver connected to the display panel through a plurality of scan lines, a plurality of sensing scan lines, and a plurality of initialization scan lines; a source driver connected to the display panel through a plurality of data lines, a plurality of readout lines, and a plurality of initialization lines; and a controller which controls the gate driver and the source driver to display an image on the display panel. In such an embodiment, each of the plurality of pixels includes a driving transistor including a gate electrode connected to a first node and connected between a first power voltage and a second node; a light-emitting element connected between the second node and a second power voltage; a first switching transistor including a gate electrode connected to a corresponding one of the plurality of scan lines, and connected between a corresponding one of the plurality of data lines and the first node; a storage capacitor connected between the first node and the second node; a second switching transistor including a gate electrode connected to a corresponding one of the plurality of sensing scan lines, and connected between a corresponding one of the plurality of readout lines, which supplies a third power voltage, and the second node; and a third switching transistor including a gate electrode connected to a corresponding one of the plurality of initialization scan lines, and connected between a corresponding one of the plurality of initialization lines, which supplies a fourth power voltage, and the second node. In such an embodiment, the second switching transistor is turned on during a first period, and the third switching transistor is turned on during a second period different from the first period.

In an embodiment, during the first period, a charging operation for a pixel may be performed to set a gate-source voltage of the driving transistor of the pixel, and during the second period, an initialization operation for the pixel may be performed to initialize the voltage of the second node in the pixel.

In an embodiment, among the plurality of pixels, the first pixel may be connected to the first scan line among the plurality of scan lines, the first data line among the plurality of data lines, the first readout line among the plurality of readout lines, and the first initialization line among the plurality of initialization lines. In such an embodiment, the second pixel among the plurality of pixels may be connected to the second scan line among the plurality of scan lines, the first data line, the first readout line, and the first initialization line. In such an embodiment, during a charging operation of the first pixel, an initialization operation of the second pixel may be performed.

In an embodiment, while the third power voltage is applied to the first pixel through the first readout line, the fourth power voltage may be applied to the second pixel through the first initialization line.

In the pixel, the display device including the pixel, and the electronic device including the display device according to embodiments of the invention, a ghosting phenomenon that may occur when the frame refresh rate is changed may be alleviated.

However, the effects of embodiments of the invention are not limited to the aforementioned effects, and various extensions can be made within the scope and spirit of the invention.

### BRIEF DESCRIPTION OF THE DRAWINGS

FIG. 1 is a diagram illustrating a display device according to an embodiment of the invention.

FIG. 2 is a diagram illustrating an embodiment of a pixel included in the display device of FIG. 1.

FIG. 3 is a signal timing diagram illustrating the operation of the display device including the pixel of FIG. 2.

FIG. 4 is a circuit diagram illustrating the operation of pixels PXLp and PXLq at time point t9 in FIG. 3.

FIG. 5 is a diagram illustrating an embodiment of an image displayed by the display device during the period between the time points t8 to t9 in FIG. 3.

FIG. 6 is a diagram illustrating another embodiment of a pixel included in the display device of FIG. 1.

FIG. 7 is a signal timing diagram illustrating the operation of the display device including the pixel of FIG. 6.

FIG. 8 is a circuit diagram illustrating the operation of pixels PXLp and PXLq at time point t29 in FIG. 7.

FIG. 9 is a diagram illustrating an embodiment of an image displayed by the display device during the period between the time points t28 to t29 in FIG. 7.

FIG. 10 is a diagram illustrating an electronic device according to another embodiment of the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms.

These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and

means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

In addition, the term “same” as used in the description may mean “substantially the same.” In other words, it may refer to a degree of similarity that those skilled in the art would recognize as substantially the same. Other terms may also be expressions where “substantially” is omitted.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

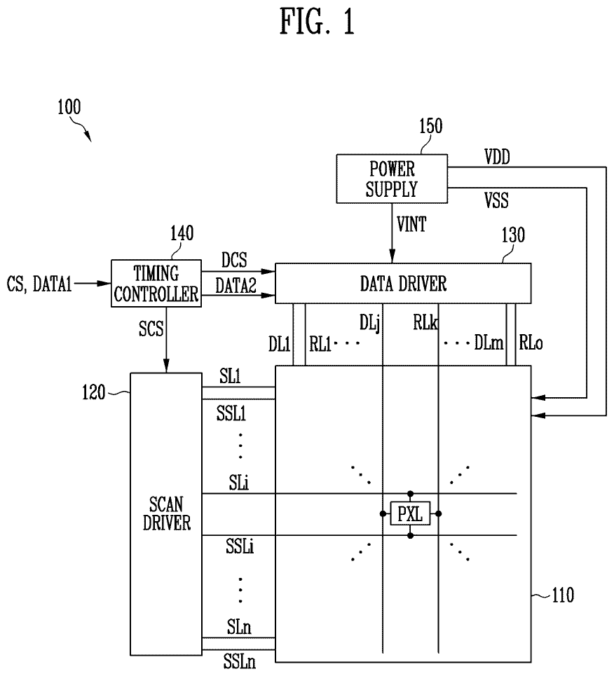

FIG. 1 is a diagram illustrating a display device according to an embodiment of the invention.

Referring to FIG. 1, an embodiment of the display device 100 may include a display 110 (or display panel), a scan driver 120 (or gate driver), a data driver 130 (or source driver), a timing controller 140, and a power supply 150. The scan driver 120, data driver 130, timing controller 140, and power supply 150 may form or collectively a driving device for driving the display 110.

The display 110 may display images. The display 110 may include scan lines SL1 to SLn, data lines DL1 to DLm, readout lines RL1 to RLo (or sensing lines), and pixels PXL (where n and m are positive integers, and o is a positive integer less than or equal to m). Additionally, the display 110 may further include sensing scan lines SSL1 to SSLn.

The pixels PXL may be positioned or located in an area (for example, a pixel area) defined by the scan lines SL1 to SLn and the data lines DL1 to DLm.

Each of the pixels PXL may be connected to a corresponding one of the scan lines SL1 to SLn and corresponding one of the data lines DL1 to DLm. Additionally, each of the pixels PXL may be connected to corresponding one of the sensing scan lines SSL1 to SSLn and corresponding one of the readout lines RL1 to RLo.

In an embodiment, for example, a pixel PXL located in an i-th row and a j-th column may be connected to an i-th scan line SLi, an i-th sensing scan line SSLi, a j-th data line DLj, and a k-th readout line RLk (where i and j are positive integers, and k is a positive integer less than or equal to j). Furthermore, the pixel PXL may be electrically connected between a first power line to which a first power voltage VDD is applied and a second power line to which a second power voltage VSS is applied. Here, the first and second power voltages VDD, VSS are the power voltages or driving voltages used for the operation of the pixel PXL, and the first power voltage VDD may have a higher voltage level than the second power voltage VSS. In an embodiment, for example, the second power voltage VSS may be about zero (0) volt (V), and the first power voltage VDD may be about 20 V. The first and second power voltages VDD, VSS may be supplied to the display 110 from the power supply 150.

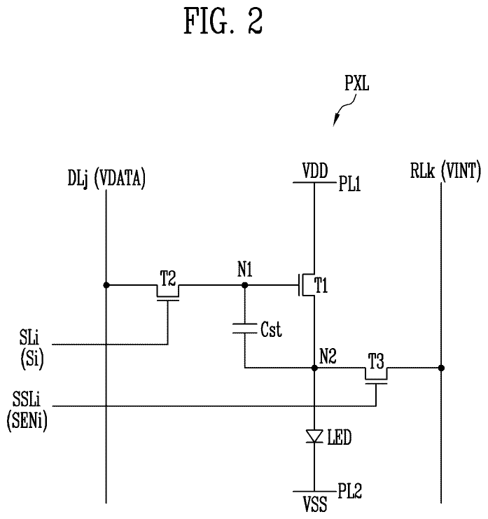

The pixel PXL may be initialized using a third power voltage VINT (or initialization voltage) supplied via the k-th readout line RLk in response to the sensing scan signal provided through the i-th sensing scan line SSLi, may store or record a data signal (or, data voltage) provided through the j-th data line DLj in response to the scan signal provided through the i-th scan line SLi, and may emit light with a luminance corresponding to the stored data signal. Here, the voltage level of the third power voltage VINT may be set lower than the operating point (or threshold voltage) of the light-emitting element in the pixel PXL. In an embodiment, for example, the third power voltage VINT may be about 2 V or about 3 V. The third power voltage VINT may be supplied to the display 110 through the data driver 130 from the power supply 150. The specific configuration of the pixel PXL will be described later with reference to FIG. 2.

The scan driver 120 may generate scan signals (or scan signals) based on the scan control signal SCS and may sequentially provide the scan signals to the scan lines SL1 to SLn. Here, the scan control signal SCS may include start signals, clock signals, or the like, and may be provided from the timing controller 140 to the scan driver 120. In an embodiment, for example, the scan driver 120 may be implemented as a shift register that generates and outputs scan signals by sequentially shifting a pulse-shaped start signal using the clock signals. Additionally, similar to the method of generating the scan signals, the scan driver 120 may generate sensing scan signals and sequentially provide the sensing scan signals to the sensing scan lines SSL1 to SSLn.

The scan driver 120 may be formed on the display 110 together with the pixel PXL. However, the invention is not limited thereto. In an embodiment, for example, the scan driver 120 may be mounted on a circuit film and connected to the timing controller 140 via at least one circuit film and a printed circuit board.

The data driver 130 may generate data signals (or data voltages) based on the image data DATA2 and the data control signal DCS provided from the timing controller 140 and may provide the data signals to the display 110 (or pixel PXL) via the data lines DL1 to DLm. Here, the data control signal DCS is a signal that controls the operation of the data driver 130 and may include a load signal (or data enable signal) indicating the output of valid data signals, a horizontal start signal, a data clock signal, etc. In an embodiment, for example, the data driver 130 may include a shift register that generates sampling signals by shifting the horizontal start signal synchronized with the data clock signal, a latch that latches the image data DATA2 in response to the sampling signals, a digital-to-analog converter (or decoder) that converts the latched image data (for example, data in digital form) into data signals in analog form, and buffers (or amplifiers) that output the data signals to the data lines DL1 to DLm. Additionally, the data driver 130 may provide the third power voltage VINT (i.e., the third power voltage VINT supplied from the power supply 150) to the display 110 (or pixel PXL) through the readout lines RL1 to RLo.

In embodiments, the data driver 130, in a separate sensing mode or sensing period (for example, in a sensing period allocated to sense the electrical characteristics of the pixel PXL, such as the threshold voltage and/or mobility of the driving transistor included in the pixel PXL), may provide a test signal (or test voltage) to the pixel PXL through the data lines DL1 to DLm and may receive sensing signals from the pixel PXL through the readout lines RL1 to RLo. The sensing signals may be used by the data driver 130 or the timing controller 140 to compensate for the electrical characteristics (or characteristic variations) of the pixel PXL. The configuration of the data driver 130 that senses the electrical characteristics of the pixel PXL will be described later with reference to FIG. 2.

In an embodiment, the sensing period may include a first period (or individual sensing period) and a second period (or reset period), and during the first period, the data driver 130 may provide the test signal to the target pixel (i.e., the pixel PXL whose electrical characteristics are to be sensed, or the data line connected to the pixel PXL), while providing a first turn-off voltage (or first off voltage) to the remaining pixels (i.e., the pixels other than the target pixel, or the data lines connected to the remaining pixels), and in the second period, may provide a second turn-off voltage (or second off voltage) to the remaining pixels (and the target pixel). Here, the test signal may have a voltage level that turns on the driving transistor provided in the pixel PXL, and the first and second turn-off voltages may have voltage levels that turn off the driving transistor. The first turn-off voltage may have a lower voltage level than the second turn-off voltage.

The data driver 130 may be mounted on a circuit film and connected to the timing controller 140 via at least one printed circuit board and/or cable.

The timing controller 140 may receive input image data DATA1 and control signals CS from an external source (for example, a graphics processor), may generate scan control signals SCS and data control signals DCS based on the control signals CS, and may also convert the input image data DATA1 to generate image data DATA2. Here, the control signals CS may include a vertical sync signal, a horizontal sync signal, a reference clock signal, or the like. The vertical sync signal may indicate the start of frame data (i.e., data corresponding to a frame period during which one frame image is displayed), and the horizontal sync signal may indicate the start of a data row (i.e., one of the plurality of data rows included in the frame data). In an embodiment, for example, the timing controller 140 may convert the input image data DATA1 into image data DATA2 having a format corresponding to the pixel array within the display 110.

The power supply 150 may supply the first power voltage VDD and the second power voltage VSS to the display 110. Additionally, the power supply 150 may provide the third power voltage VINT to the data driver 130. Furthermore, the power supply 150 may supply the power voltage to at least one selected from the scan driver 120, the data driver 130, and the timing controller 140 for driving thereof. The power supply 150 may be implemented as a power management integrated circuit (PMIC).

At least one selected from the scan driver 120, the data driver 130, the timing controller 140, and the power supply 150 may be formed on the display 110, or implemented as an integrated circuit and connected to the display 110 in the form of a tape carrier package. Additionally, at least two selected from the scan driver 120, the data driver 130, the timing controller 140, and the power supply 150 may be implemented as a single integrated circuit. In an embodiment, for example, the data driver 130 and the timing controller 140 may be implemented as a single integrated circuit.

FIG. 2 is a diagram illustrating an embodiment of a pixel included in the display device of FIG. 1. A pixel PXL located in the i-th row and j-th column is shown in FIG. 2 as an example.

Referring to FIG. 2, in an embodiment, the pixel PXL may be connected to the i-th scan line SLi, the j-th data line DLj, the i-th sensing scan line SSLi, and the k-th readout line RLk.

In an embodiment, the pixel PXL may include a light-emitting element LED, a first transistor T1 (also referred to as driving transistor), a second transistor T2 (also referred to as first switching transistor), a third transistor T3 (also referred to as sensing transistor, second switching transistor or initialization transistor), and a storage capacitor Cst. The first transistor T1, the second transistor T2, and the third transistor T3 may each be thin-film transistors including oxide semiconductors, but is not limited thereto. In an embodiment, for example, at least one selected from the first transistor T1, the second transistor T2, and the third transistor T3 may include polysilicon semiconductors or may be implemented as N-type or P-type semiconductors.

The first electrode (or anode electrode) of the light-emitting element LED may be connected (or electrically connected) to a second node N2 (or the second electrode of the first transistor T1). The first electrode of the light-emitting element LED may be connected (or electrically connected) to the first power line PL1 via the first transistor T1. The first power voltage VDD may be applied to the first power line PL1. The second electrode (or cathode electrode) of the light-emitting element LED may be connected to the second power line PL2. The second power voltage VSS may be applied to the second power line PL2. The light-emitting element LED may generate light with a predetermined luminance corresponding to the amount of current (or driving current) supplied from the first transistor T1. The light-emitting element LED may be composed of an organic light-emitting diode (OLED), or an inorganic light-emitting diode such as a micro-light-emitting diode or a quantum dot light-emitting diode. Additionally, the light-emitting element may also be composed of a light-emitting diode formed by a combination of organic and inorganic materials.

The first electrode (for example, drain electrode) of the first transistor T1 may be connected to the first power line PL1, and the second electrode (for example, source electrode) may be connected to the second node N2 (or the anode electrode of the light-emitting element LED). The gate electrode of the first transistor T1 may be connected to a first node N1. The first transistor T1 may control the amount of current flowing to the light-emitting element LED in response to the voltage of the first node N1 (or the gate-source voltage applied between the second electrode and the gate electrode of the first transistor T1).

The first electrode of the second transistor T2 may be connected to the j-th data line DLj, and the second electrode may be connected to the first node N1. The gate electrode of the second transistor T2 may be connected to the i-th scan line SLi. When the i-th scan signal Si is supplied to the i-th scan line SLi, the second transistor T2 may turn on, thereby allowing the data signal VDATA (or data voltage) from the j-th data line DLj to be transmitted to the first node N1.

The storage capacitor Cst may be formed or connected between the first node N1 and the first electrode of the light-emitting element LED. The storage capacitor Cst may store the voltage of the first node N1, or a charge corresponding to the voltage of the first node N1 may be charged into the storage capacitor Cst.

The first electrode of the third transistor T3 may be connected to the second node N2 (or the second electrode of the first transistor T1), and the second electrode of the third transistor T3 may be connected to the k-th readout line RLk. The gate electrode of the third transistor T3 may be connected to the i-th sensing scan line SSLi. The third transistor T3 may connect the second node N2 and the k-th readout line RLk in response to the sensing scan signal SENi, such that the third power voltage VINT applied to the k-th readout line RLk may be applied to the second node N2. Accordingly, the voltage of the second node N2 or the first electrode of the light-emitting element LED may be initialized by the third power voltage VINT.

When the second transistor T2 and the third transistor T3 are turned on simultaneously in response to the i-th scan signal S1 and the sensing scan signal SENi, the voltage difference between the data signal VDATA and the third power voltage VINT may be stored in the storage capacitor Cst, and the first transistor T1 may control the amount of current flowing to the light-emitting element LED in response to the voltage difference stored in the storage capacitor Cst.

When the third transistor T3 maintains the connection between the second node N2 and the k-th readout line RLk in response to the sensing scan signal SENi, a sensing signal (or current amount) corresponding to the voltage difference (i.e., the voltage difference between the data signal VDATA and the third power voltage VINT) may be output from the pixel PXL through the k-th readout line RLk. In an embodiment, for example, during the sensing period, if the first transistor T1 is turned on by the test signal (i.e., the test signal or test voltage applied as the data signal VDATA), the current flowing through the first transistor T1 in response to the test signal may be output as a sensing signal through the k-th readout line RLk.

I embodiments of the invention, the pixel PXL is not limited to the circuit structure shown in FIG. 2. The pixel PXL can be implemented in various ways other than the circuit shown in FIG. 2.

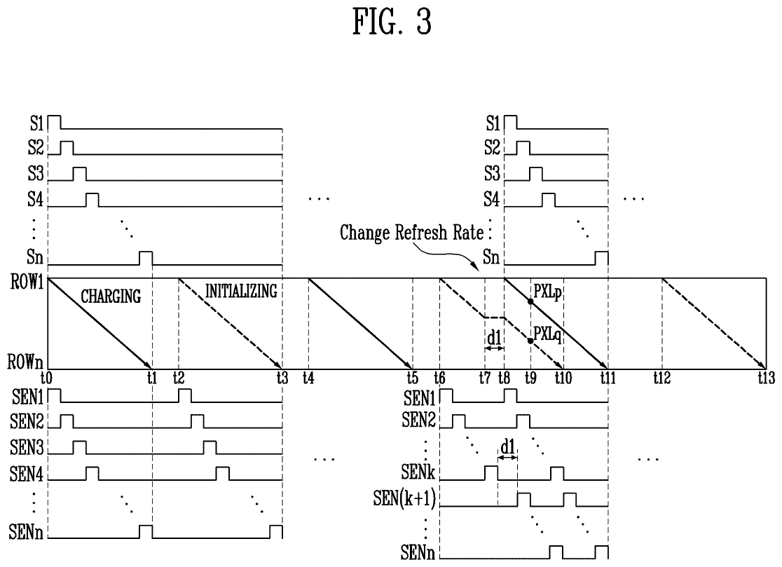

FIG. 3 is a signal timing diagram illustrating the operation of the display device including the pixel shown in FIG. 2.

Referring to FIG. 3, the signal timing diagram shows the charging and initialization operations for the pixels in a first to n-th rows ROW1 to ROWn, scan signals S1 to Sn applied to the scan lines SL1 to SLn during each operation, and the timing of the sensing scan signals SEN1 to SENn applied to the sensing scan lines SSL1 to SSLn. The pixels in the first row ROW1 are the m pixels connected to the first scan line SL1, and the pixels in the second row ROW2 are the m pixels connected to the second scan line SL2. In FIG. 3, the charging operation performed on the pixels connected to each row over time is represented by solid arrows, and the initialization operation performed on the pixels connected to each row over time is represented by dotted arrows.

During the period between the time points t0 to t1 (e.g., a period from the time point t0 to the time point t1), the charging operation is performed for the pixels in the first to n-th rows ROW1 to ROWn. Accordingly, during the period between the time points t0 to t1, the scan signals S1 to Sn are sequentially applied to the first to n-th scan lines SL1 to SLn, and the sensing scan signals SEN1 to SENn may be sequentially applied to the first to n-th sensing scan lines SSL1 to SSLn.

The period between the time points t1 to t2 may be a blank interval. Subsequently, during the period between the time points t2 to t3, the initialization operation for the pixels may be performed. To this end, during the period between the time points t2 to t3, the sensing scan signals SEN1 to SENn may be sequentially applied to the first to n-th sensing scan lines SSL1 to SSLn. Accordingly, the third transistors T3 of the pixels each connected to the first to n-th rows ROW1 to ROWn may be sequentially turned on for each row, and the voltage of the anode electrode of the light-emitting element (LED) included in each pixel may be initialized.

The period between the time points t3 to t4 may be a blank interval. Afterward, during the period between the time points t4 to t5, a charging operation similar to that performed during the period between the time points t0 to t1 may be performed in a same manner.

Afterward, at time point t6, the initialization operation may begin with the pixels in the first row ROW1. In an embodiment, as shown in FIG. 3, the frame refresh rate of the display device 100 may change at time point t7. In such an embodiment, for example, the scan rate of the display device 100 before time point t7 may be relatively high (for example, about 120 hertz (Hz)), and the scan rate of the display device 100 after time point t7 may be relatively lower (for example, about 95 Hz). In this case, the application of the sensing scan signal may be suspended until the start of the new frame at time point t8. Referring to FIG. 3, the time point t7 may be a time point at which the k-th sensing scan signal SENk is applied to the k-th sensing scan line SSLk. After a time period corresponding to a length d1 of the period between the time points t7 to t8, the (k+1)-th sensing scan signal SEN (k+1) may be applied to the (k+1)-th sensing scan line SSL (k+1) at time point t8. In such an embodiment, during the period between the time points t8 to t10, the (k+1)-th sensing scan signal SEN (k+1) to the n-th sensing scan signal SENn are applied to the (k+1)-th sensing scan line SSL (k+1) to the n-th sensing scan line SSLn.

In such an embodiment, at time point t8, the charging operation may start from the pixels in the first row ROW1. Accordingly, during the period between the time points t8 to t11, the scan signals S1 to Sn may be sequentially applied to the first to n-th scan lines SL1 to SLn, and sensing scan signals SEN1 to SENn may be sequentially applied to the first to n-th sensing scan lines SSL1 to SSLn.

The period between the time points t11 to t12 may be a blank interval. Since the frame refresh rate has been changed, the length of the period between the time points t11 to t12 may be different from the length of the previous blank intervals, such as period between the time points t1 to t2 or period between the time points t3 to t4. As described above, when the frame refresh rate decreases at time point t7, the length of period between the time points t11 to t12 may be longer than that of period between the time points t1 to t2 or period between the time points t3 to t4. Afterward, during the period between the time points t12 to t13, a charging operation similar to that performed during period between the time points t0 to t1 or period between the time points t4 to t5 may be performed.

Referring to FIG. 3, in an embodiment, during the period between the time points t8 to t10, two sensing scan signals are applied to the corresponding sensing scan lines simultaneously. In the embodiment of FIG. 3, the first sensing scan signal SEN1 and the (k+1)-th sensing scan signal SEN (k+1) are simultaneously applied to the first sensing scan line SSL1 and the (k+1)-th sensing scan line SSL (k+1), respectively. The third transistors T3 of the pixels located in a same column are commonly connected to one readout line RL.

Accordingly, the initialization operation respectively performed on the pixels in (k+1)-th to n-th rows ROW (k+1) to ROWn may affect the charging operation respectively performed on the pixels in first to (n−k)-th rows ROW1 to ROW (n−k). More specifically, the initialization operation sequentially performed on the pixels each connected to any one column (for example, the j-th column) among the pixels in the (k+1)-th to n-th rows ROW (k+1) to ROWn may affect the charging operation sequentially performed on the pixels each connected to the corresponding column (for example, the j-th column) among the pixels in the first to (n−k)-th rows ROW1 to ROW (n−k). This results in a decrease in the image quality displayed by the display device 100.

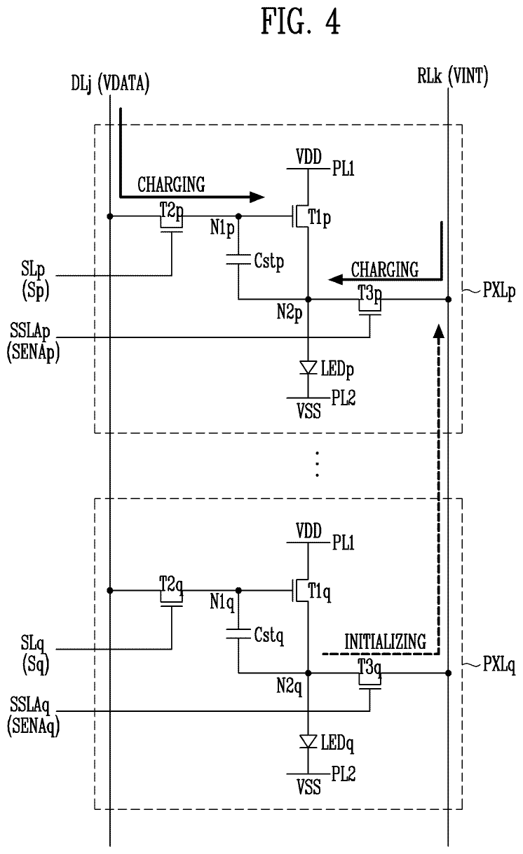

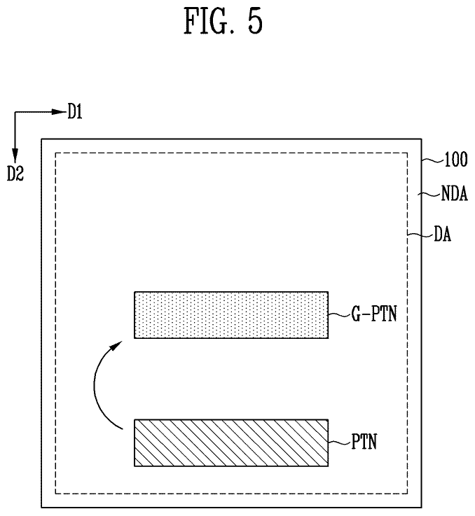

In an embodiment, for example, at time point t9, sensing scan signals may be simultaneously applied to a p-th pixel PXLp and a q-th pixel PXLq. In such an embodiment, the p-th pixel PXLp and the q-th pixel PXLq are located in a same column and are commonly connected to one readout line. Accordingly, the charging operation of the p-th pixel PXLp may be affected by the initialization operation of the q-th pixel PXLq. Hereinafter, a more detailed explanation will be provided below with reference to FIG. 4 and FIG. 5.

FIG. 4 is a circuit diagram illustrating the operation of the pixels PXLp and PXLq at time point t9 in FIG. 3.

In FIG. 4, the p-th pixel PXLp and the q-th pixel PXLq located in the j-th column are shown. The p-th pixel PXLp may be connected to a p-th scan line SLp, the j-th data line DLj, a p-th sensing scan line SSLp, and the k-th readout line RLk. Additionally, the p-th pixel PXLp may include a light-emitting element LEDp, a first transistor T1p, a second transistor T2p, a third transistor T3p, and a storage capacitor Cstp.

The first electrode of the light-emitting element LEDp may be connected to the second node N2p. The first electrode of the light-emitting element LEDp may be connected to the first power line PL1 via the first transistor Tlp. The first electrode (for example, drain electrode) of the first transistor Tlp may be connected to the first power line PL1, and the second electrode (for example, source electrode) may be connected to the second node N2p. The gate electrode of the first transistor T1p may be connected to the first node N1p.

The first electrode of the second transistor T2p may be connected to the j-th data line DLj, and the second electrode may be connected to the first node N1p. The gate electrode of the second transistor T2p may be connected to the p-th scan line SLp.

The storage capacitor Cstp may be formed or connected between the first node N1p and the first electrode of the light-emitting element LEDp. The first electrode of the third transistor T3p may be connected to the second node N2p, and the second electrode of the third transistor T3p may be connected to the k-th readout line RLk. The gate electrode of the third transistor T3p may be connected to the p-th sensing scan line SSLp.

In such an embodiment, the q-th pixel PXLq may be connected to a q-th scan line SLq, the j-th data line DLj, a q-th sensing scan line SSLq, and the k-th readout line RLk. The q-th pixel PXLq may also include a light-emitting element LEDq, a first transistor T1q, a second transistor T2q, a third transistor T3q, and a storage capacitor Cstq.

The first electrode of the light-emitting element LEDq may be connected to the second node N2q. The first electrode of the light-emitting element LEDq may be connected to the first power line PL1 via the first transistor T1q. The first electrode (for example, drain electrode) of the first transistor T1q may be connected to the first power line PL1, and the second electrode (for example, source electrode) may be connected to the second node N2q.

The gate electrode of the first transistor T1q may be connected to the first node N1q.

The first electrode of the second transistor T2q may be connected to the j-th data line DLj, and the second electrode may be connected to the first node N1q. The gate electrode of the second transistor T2q may be connected to the q-th scan line SLq.

The storage capacitor Cstq may be formed or connected between the first node N1q and the first electrode of the light-emitting element LEDq. The first electrode of the third transistor T3q may be connected to the second node N2q, and the second electrode of the third transistor T3q may be connected to the k-th readout line RLk. The gate electrode of the third transistor T3q may be connected to the q-th sensing scan line SSLq.

In an embodiment, at time point t9 in FIG. 3, a charging operation is performed for the p-th pixel PXLp, and an initialization operation is performed for the q-th pixel PXLq. Specifically, at time point t9, the second and third transistors T2p and T3p of the p-th pixel PXLp are turned on by the p-th scan signal Sp and the p-th sensing scan signal SENp, which are activated at this time, thereby performing the charging operation for the p-th pixel PXLp.

In such an embodiment, at time point t9, the third transistor T3q of the q-th pixel PXLq is turned on by the q-th sensing scan signal SENq, which are activated at this time, thereby performing the initialization operation for the q-th pixel PXLq.

The third power voltage VINT, i.e., the initialization voltage, may be applied to the k-th readout line RLk. However, as the initialization operation for the q-th pixel PXLq is performed at time point t9, the voltage of the k-th readout line RLk may slightly change. This may affect the charging operation of the p-th pixel PXLp. In other words, as the voltage of the k-th readout line RLk changes, the voltage of the second node N2p of the p-th pixel PXLp may also change. The gate-source voltage of the first transistor Tlp of the p-th pixel PXLp may change, which in turn affects the luminance of the light generated by the light-emitting element LED of the p-th pixel PXLp.

FIG. 5 is a diagram illustrating an embodiment of an image displayed by the display device during the period between the time points t8 to t9 in FIG. 3.

In FIG. 5, the display area DA and the non-display area NDA of the display device 100 are shown. A plurality of pixels may be positioned in the display area DA. In FIG. 5, a pattern PTN may be displayed at the lower portion of the display area. The pattern PTN shown in FIG. 5 may represent a relatively bright area compared to its surroundings.

As described above, during the period between the time points t8 to t9 in FIG. 3, the initialization operation for the relatively lower-positioned q-th pixel PXLq may affect the charging operation of the relatively upper-positioned p-th pixel PXLp. Referring to both FIG. 5 and FIG. 4, the q-th pixel may be a pixel correspond to the pattern PTN in FIG. 5. The q-th pixel PXLq, which generates relatively bright light, may cause a significant change in the voltage of the k-th readout line RLk during its initialization operation.

As the voltage of the readout line RLk rises, the voltage of the second node N2p of the p-th pixel PXLp may rise. Therefore, as the gate-source voltage of the first transistor T1p of the p-th pixel PXLp decreases, the luminance of the light generated by the light-emitting element LEDp of the p-th pixel PXLp decreases.

Thus, as shown in FIG. 5, a ghost pattern G-PTN may be recognized in the upper area of the pattern PTN. The ghost pattern G-PTN may be recognized as a relatively dark area compared to its surroundings. This phenomenon may occur when the frame refresh rate of the display device 100 changes.

According to embodiments illustrated in FIGS. 2 to 5, the third transistor in the pixel is turned on during both the charging and initialization operations for the pixel. Since the voltage used for the charging operation of the pixel and the voltage used for the initialization operation of the pixel are supplied through a single column-direction line, i.e., the readout line, the initialization operation for any one pixel among the pixels located in a same column may act as noise to the charging operation of other pixels. As a result, when the frame refresh rate of the display device 100 changes, a ghost pattern perceived in the relatively upper portion of the display area DA may occur due to the bright pattern displayed in the relatively lower portion of the display area DA. This leads to a degradation in the image quality displayed by the display device 100.

According to another embodiment of the invention, the pixel included in the display device receives the voltage used during the charging operation and the voltage used during the initialization operation through different column-direction lines. As a result, the initialization operation performed on any one pixel among the pixels located in the same column may not affect the charging operation performed on another pixel simultaneously. Thus, the image quality displayed by the display device may be improved.

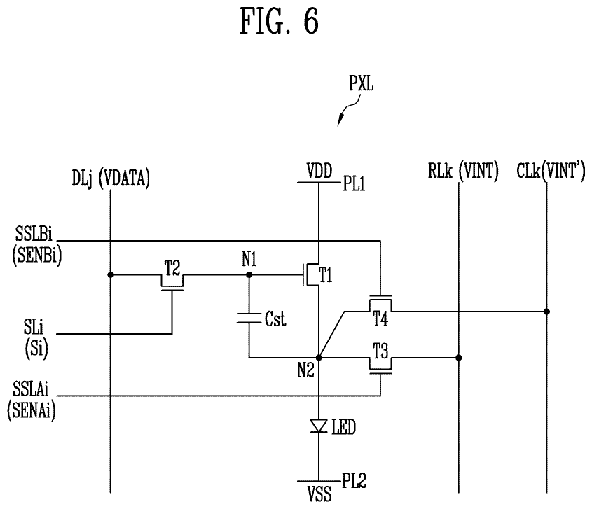

FIG. 6 is a diagram illustrating another embodiment of the pixel included in the display device shown in FIG. 1.

Referring to FIG. 6, the pixel PXL may be connected to the i-th scan line SLi, the j-th data line DLj, the i-th sensing scan line SSLAi, the i-th initialization scan line SSLBi, the k-th readout line RLk, and the k-th initialization line CLk.

The pixel PXL may include a light-emitting element LED, a first transistor T1 (also referred to as driving transistor), a second transistor T2 (also referred to as first switching transistor), a third transistor T3 (also referred to as sensing transistor, second switching transistor), a fourth transistor T4 (also referred to as initialization transistor or third switching transistor), and a storage capacitor Cst. In the pixel PXL shown in FIG. 6, the connection structure of the first to third transistors, the light-emitting element LED, and the storage capacitor Cst is the same as that of the pixel shown in FIG. 2. Therefore, any repetitive descriptions thereof will be omitted.

The first electrode of the third transistor T3 may be connected to the second node N2 (or the second electrode of the first transistor T1), and the second electrode of the third transistor T3 may be connected to the k-th readout line RLk. The gate electrode of the third transistor T3 may be connected to the i-th sensing scan line SSLAi. The third transistor T3 may connect the second node N2 and the k-th readout line RLk in response to the sensing scan signal SENAi. In such an embodiment, the third power voltage VINT applied to the k-th readout line RLk may be applied to the second node N2. When the second transistor T2 and the third transistor T3 are simultaneously turned on in response to the i-th scan signal Si and the sensing scan signal SENAi, the voltage difference between the data signal VDATA and the third power voltage VINT may be stored in the storage capacitor Cst, and the first transistor T1 may control the amount of current flowing to the light-emitting element LED in response to the voltage difference stored in the storage capacitor Cst.

In an embodiment, as shown in FIG. 6, the pixel may further include the fourth transistor T4. The first electrode of the fourth transistor T4 may be connected to the second node N2 (or the second electrode of the first transistor T1), and the second electrode of the fourth transistor T4 may be connected to the k-th initialization line CLK. The gate electrode of the fourth transistor T4 may be connected to the i-th initialization scan line SSLBi. The fourth transistor T4 may connect the second node N2 and the k-th initialization line CLk in response to the initialization scan signal SENBi. In such an embodiment, a fourth power voltage VINT′ applied to the k-th initialization line CLK may be applied to the second node N2. The voltage of the second node N2 or the first electrode of the light-emitting element LED may be initialized by the fourth power voltage VINT′

In an embodiment, the third power voltage VINT and the fourth power voltage VINT′ may be a same voltage. In another embodiment, the third power voltage VINT and the fourth power voltage VINT′ may be different voltages.

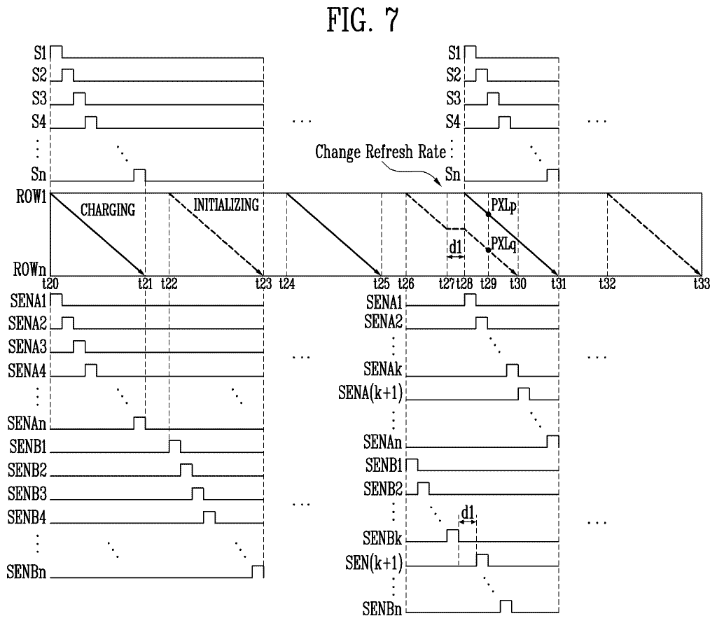

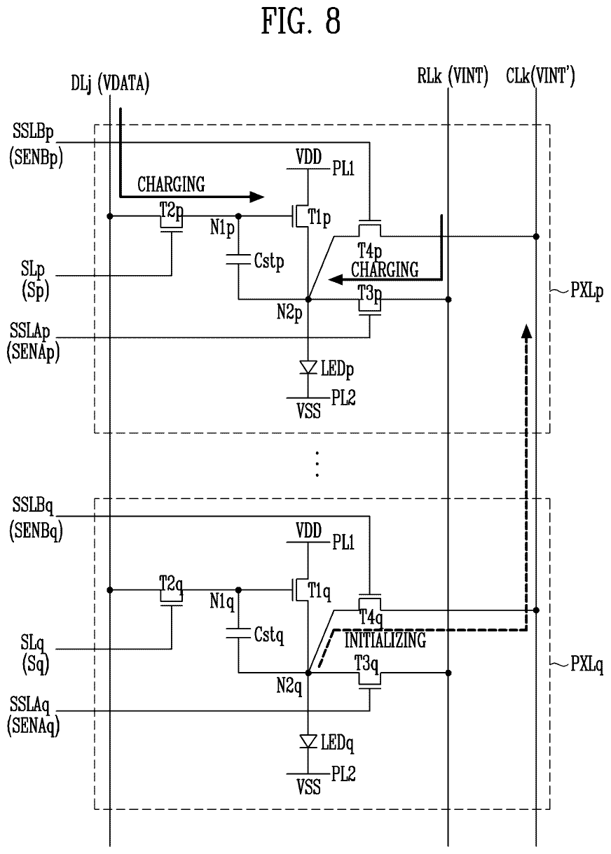

According to an embodiment of the pixel PXL, as shown in FIG. 6, during the charging operation, the third transistor T3 is turned on, thereby connecting the second node N2 and the k-th readout line RLk, and during the initialization operation, and the fourth transistor T4 is turned on, thereby connecting the second node N2 and the k-th initialization line CLk. In other words, the pixel receives the third power voltage VINT used during the charging operation and the fourth power voltage VINT′ used during the initialization operation through different lines. As a result, the initialization operation performed on any one pixel among the pixels located in a same column may not affect the charging operation being performed simultaneously on another pixel such that the image quality displayed by the display device may be improved. The operation will be described in more detail with reference to FIGS. 7 and 8 below.

FIG. 7 is a signal timing diagram illustrating the operation of the display device including the pixel shown in FIG. 6.

Referring to FIG. 7, the signal timing diagram illustrates the charging operation and initialization operation for the pixels from the first row ROW1 to the n-th row ROWn, as well as the scan signals S1 to Sn applied to the scan lines SL1 to SLn, the sensing scan signals SENA1 to SENAn applied to the sensing scan lines SSLA1 to SSLAn, and the initialization scan signals SENB1 to SENBn applied to the initialization scan lines SSLB1 to SSLBn during each operation. The pixels in the first row ROW1 are m pixels connected to the first scan line SL1, and the pixels in the second row ROW2 are m pixels connected to the second scan line SL2. In FIG. 7, the charging operation performed on the pixels connected to each row over time is represented by solid arrows, and the initialization operation performed on the pixels connected to each row over time is represented by dashed arrows.

During the period between the time points t20 to t21, the charging operation for the pixels in the first row ROW1 to the n-th row ROWn is performed. Accordingly, during the period between the time points t20 to t21, scan signals S1 to Sn may be sequentially applied to the first to the n-th scan lines SL1 to SLn, and sensing scan signals SENA1 to SENAn may be sequentially applied to the first to the n-th sensing scan lines SSLA1 to SSLAn.

The period between the time points t21 to t22 may be a blank interval. Subsequently, during the period between the time points t22 to t23, the initialization operation for the pixels may be performed. In such an embodiment, during the period between the time points t22 to t23, initialization scan signals SENB1 to SENBn may be sequentially applied to the first to the n-th initialization scan lines SSLB1 to SSLBn. As a result, the fourth transistor T4 of the pixels connected to the first row ROW1 to the n-th row ROWn may be sequentially turned on for each row, and the voltage of the anode electrode of the light-emitting element LED included in each pixel may be initialized.

The period between the time points t23 to t24 may be a blank interval. Afterward, during the period between the time points t24 to t25, the same charging operation as that performed during the period between the time points t20 to t21 may be performed. In such an embodiment, at time point t26, the initialization operation for the pixels

in the first row ROW1 may begin. In an embodiment, as shown in FIG. 7, the frame refresh rate of the display device 100 may change at time point t27. Referring to FIG. 7, at time point t27, the k-th initialization scan signal SENBk is applied to the k-th initialization scan line SSLBk. After the period between the time points t27 to t28 with a length of d1, the (k+1)-th initialization scan signal SENB (k+1) may be applied to the (k+1)-th initialization scan line SSLB (k+1) at time point t28. That is, during the period between the time points t28 to t30, the (k+1)-th initialization scan signal SENB (k+1) to the n-th initialization scan signal SENBn are applied to the (k+1)-th initialization scan line SSLB (k+1) to the n-th initialization scan line SSLBn.

In an embodiment, at time point t28, the charging operation may start from the pixels in the first row ROW1. Accordingly, during the period between the time points t28 to t31, scan signals S1 to Sn may be sequentially applied to the first to the n-th scan lines SL1 to SLn, and sensing scan signals SENA1 to SENAn may be sequentially applied to the first to the n-th sensing scan lines SSLA1 to SSLAn.

The period between the time points t31 to t32 may be a blank interval. Since the frame refresh rate has changed, the length of the period between the time points t31 to t32 may be different from the length of the previously described blank intervals such as the period between the time points t21 to t22 or the period between the time points t23 to t24. Subsequently, during the period between the time points t32 to t33, the charging operation similar to that performed during the period between the time points t20 to t21 or the period between the time points t24 to t25 may be performed.

Referring to FIG. 7, in an embodiment, during the period between the time points t28 to t30, the initialization scan signals for the pixel initialization operation and the sensing scan signals for the pixel charging operation are individually applied to the pixels. In an embodiment, as shown in FIG. 6, the second node N2 may be individually connected to separate column-direction lines, specifically the k-th readout line RLk and the k-th initialization line CLK, by the initialization scan signal and the sensing scan signal.

As a result, the initialization operation respectively performed on the pixels in the (k+1)-th row ROW (k+1) to the n-th row ROWn may not affect the charging operation being performed on the pixels in the first row ROW1 to the (n-k)-th row ROW (n-k). More specifically, the initialization operation sequentially performed on the pixels connected to any one column (for example, the j-th column) among the pixels in the (k+1)-th row ROW (k+1) to the n-th row ROWn does not affect the charging operation being sequentially performed on the pixels respectively connected to the corresponding column (for example, the j-th column) among the pixels in the first row ROW1 to the (n-k)-th row ROW (n-k) such that the image quality displayed by the display device 100 may be enhanced.

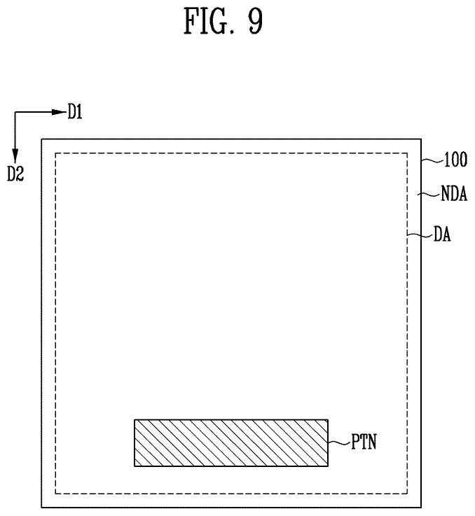

In an embodiment, for example, at time point t29, a sensing scan signal may be applied to the p-th pixel PXLp, and an initialization scan signal may be applied to the q-th pixel PXLq. The charging operation for the p-th pixel PXLp is performed through the readout line by the sensing scan signal, and the initialization operation for the q-th pixel PXLq is performed by the initialization scan signal. Hereinafter, such operations will be described in greater detail with reference to FIGS. 8 and 9.

FIG. 8 is a circuit diagram illustrating the operation of the pixels PXLp and PXLq at time point t29 in FIG. 7.

Referring to FIG. 8, in an embodiment, the p-th pixel PXLp and the q-th pixel PXLq, which are located in the j-th column, are illustrated. The p-th pixel PXLp may be connected to the p-th scan line SLp, the j-th data line DLj, the p-th sensing scan line SSLAp, the p-th initialization scan line SSLBp, the k-th readout line RLk, and the k-th initialization line CLk. The p-th pixel PXLp may also include a light-emitting element LEDp, a first transistor T1p, a second transistor T2p, a third transistor T3p, a fourth transistor T4p, and a storage capacitor Cstp.

In such an embodiment, the q-th pixel PXLq may be connected to the q-th scan line SLq, the j-th data line DLj, the q-th sensing scan line SSLAq, the q-th initialization scan line SSLBq, the k-th readout line RLk, and the k-th initialization line CLK. The q-th pixel PXLq may also include a light-emitting element LEDq, a first transistor T1q, a second transistor T2q, a third transistor T3q, a fourth transistor T4q, and a storage capacitor Cstq.

At time point t29 in FIG. 7, the charging operation for the p-th pixel PXLp is performed, while the initialization operation for the q-th pixel PXLq is performed. Specifically, the p-th scan signal Sp and the p-th sensing scan signal SENAp, which are activated at time point t29, turn on the second and third transistors T2p, T3p of the p-th pixel PXLp, allowing the charging operation for the p-th pixel PXLp to be carried out.

In an embodiment, by the q-th initialization scan signal SENBq activated at time point t29, the fourth transistor T4q of the q-th pixel PXLq is turned on, and the initialization operation for the q-th pixel PXLq is performed.

The k-th initialization line CLK may be supplied with the fourth power voltage VINT′, that is, the initialization voltage. As the initialization operation is performed for the q-th pixel PXLq at time point t29, the voltage of the k-th initialization line CLk may slightly change.

In such an embodiment, the charging operation for the p-th pixel PXLp is performed using the k-th readout line RLk, not the k-th initialization line CLK. Therefore, the voltage change of the k-th initialization line CLK may not affect the charging operation of the p-th pixel PXLp. In other words, since the voltage change of the k-th initialization line CLK may not influence the voltage of the k-th readout line RLk, the luminance of the light emitted by the light-emitting element LED of the p-th pixel PXLp may also not be affected by the voltage change of the k-th initialization line CLk.

FIG. 9 is a diagram illustrating an embodiment of an image displayed by the display device during the period between the time points t28 to t29 in FIG. 7.

Referring to FIG. 9, the display area DA and non-display area NDA of the display device 100 are shown. A plurality of pixels may be located in the display area DA. In FIG. 9, a pattern PTN may be displayed at the lower portion of the display area. The pattern PTN displayed in FIG. 9 may be a relatively brighter portion compared to its surroundings.

In an embodiment, as described above, during the period between the time points t28 to t29 in FIG. 7, the initialization operation for the q-th pixel PXLq, located relatively at the lower portion, may not affect the charging operation of the p-th pixel PXLp, located relatively at the upper portion. Therefore, even when the frame refresh rate of the display device 100 changes, unlike FIG. 5, no ghost pattern is visible in the upper area of the pattern PTN in FIG. 9.

According to embodiments, as shown in FIGS. 6 to 9, during the charging operation of the pixel, the third transistor turns on, connecting the second node N2 to the k-th readout line RLk, while the fourth transistor turns off, disconnecting the second node N2 from the k-th initialization line CLK. In such embodiments, during the initialization operation of the pixel, the fourth transistor turns on, connecting the second node N2 to the k-th initialization line CLk, while the third transistor turns off, disconnecting the second node N2 from the k-th readout line RLk. Since the voltage used for the charging operation of the pixel and the voltage used for the initialization operation of the pixel are each separately supplied through different column-direction lines, i.e., the readout line and the initialization line, the initialization operation of a corresponding one pixel among the pixels located in a same column may not affect the charging operation of other pixel. As a result, when the frame refresh rate of the display device 100 changes, even if a bright pattern is displayed at the relatively lower portion of the display area DA, no ghost pattern occurs thereby. Therefore, the quality of the image displayed by the display device 100 is improved.

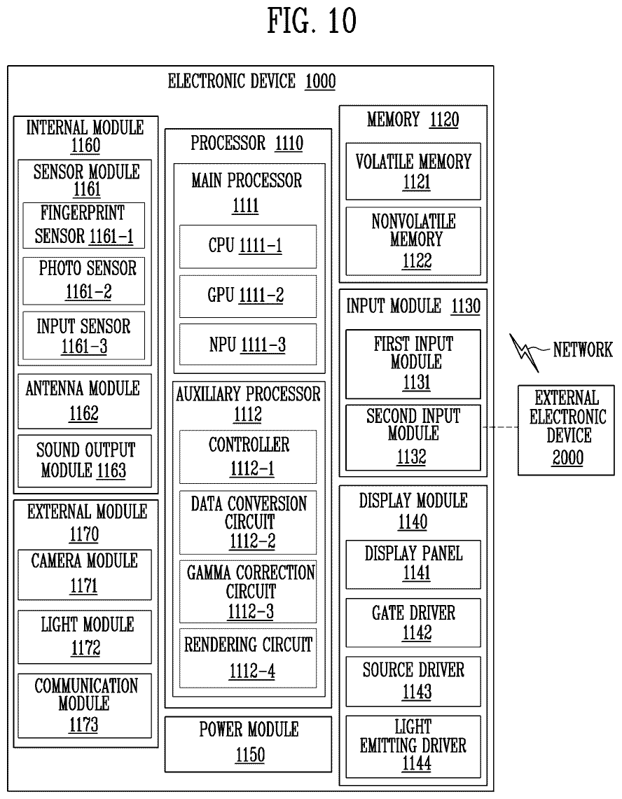

FIG. 10 is a diagram illustrating an electronic device according to another embodiment of the invention.

Referring to FIG. 10, the electronic device according to an embodiment of the invention outputs various information through the display module 1140. The display module 1140 may correspond to at least a part of the display device 100 or 101 of FIG. 1. In such an embodiment, the display panel 1141 of the display module 1140 may include pixels corresponding to those shown in FIG. 6.

When the processor 1110 executes an application stored in the memory 1120, the display module 1140 provides the application information to the user through the display panel 1141. The display panel 1141 may be in a configuration corresponding to the display 110 of FIG. 1.

The processor 1110 acquires external input through the input module 1130 or the sensor module 1161 and executes the application corresponding to the external input. For example, when the user selects a camera icon displayed on the display panel 1141, the processor 1110 acquires the user input through the input sensor 1161-3 and activates the camera module 1171. The processor 1110 transmits the image data corresponding to the captured image obtained through the camera module 1171 to the display module 1140. The display module 1140 may display the image corresponding to the captured image through the display panel 1141.

In another example, when personal information authentication is executed on the display module 1140, the fingerprint sensor 1161-1 acquires the entered fingerprint information as input data. The processor 1110 compares the input data acquired through the fingerprint sensor 1161-1 with the authentication data stored in the memory 1120 and executes the application based on the comparison result. The display module 1140 may display the information executed according to the application's logic through the display panel 1141.

In yet another example, when the music streaming icon displayed on the display module 1140 is selected, the processor 1110 acquires the user input through the input sensor 1161-3 and activates the music streaming application stored in the memory 1120. When a music playback instruction is input in the music streaming application, the processor 1110 activates the sound output module 1163 to provide sound information corresponding to the music playback instruction to the user.

The operation of the electronic device 1000 is briefly described above. The configuration of the electronic device 1000 will be described in greater detail below. Some components of the electronic device 1000 to be described later may be integrated into a single component, or one component may be divided into two or more components.

The electronic device 1000 may communicate with an external electronic device 2000 through a network (for example, a short-range wireless communication network or a long-range wireless communication network). According to an embodiment, the electronic device 1000 may include a processor 1110, a memory 1120, an input module 1130, a display module 1140, a power module 1150, an internal module 1160, and an external module 1170. In an embodiment, at least one of the aforementioned components of the electronic device 1000 may be omitted, or one or more additional components may be included. In an embodiment, some of the aforementioned components (for example, sensor module 1161, antenna module 1162, or sound output module 1163) may be integrated into another component (for example, display module 1140).

The processor 1110 may execute software to control at least one other component of the electronic device 1000 (for example, a hardware or software component) connected to the processor 1110, and may perform various data processing or computations. According to an embodiment, as at least a part of the data processing or computation, the processor 1110 may store instructions or data received from other components (for example, input module 1130, sensor module 1161, or communication module 1173) in volatile memory 1121, process the instructions or data stored in volatile memory 1121, and store the resulting data in non-volatile memory 1122.

The processor 1110 may include a main processor 1111 and an auxiliary processor 1112. The auxiliary processor 1112 may correspond to at least a part of the configuration of the timing controller 140 shown in FIG. 1.

The main processor 1111 may include at least one selected from a central processing unit 1111-1 (CPU) or an application processor (AP). The main processor 1111 may further include at least one selected from a graphic processing unit 1111-2 (GPU), a communication processor (CP), or an image signal processor (ISP). The main processor 1111 may further include a neural processing unit 1111-3 (NPU). The neural processing unit is a processor specialized for processing artificial intelligence models, which may be generated through machine learning. The artificial intelligence model may include a plurality of artificial neural network layers. The artificial neural network may be a deep neural network (DNN), convolutional neural network (CNN), recurrent neural network (RNN), restricted Boltzmann machine (RBM), deep belief network (DBN), bidirectional recurrent deep neural network (BRDNN), deep Q-networks, or one combination of two or more of the above, but is not limited to these examples. The artificial intelligence model may additionally or alternatively include a software structure aside from the hardware structure. At least two selected from the aforementioned processing units and processors may be implemented as a single integrated configuration (for example, a single chip) or as independent configurations (for example, multiple chips).

The auxiliary processor 1112 may include a controller 1112-1. The controller 1112-1 may include an interface conversion circuit and a timing control circuit. The controller 1112-1 receives image signals from the main processor 1111, converts the data format of the image signals to match the interface specifications of the display module 1140, and outputs the image data.

The auxiliary processor 1112 may further include a data conversion circuit 1112-2, a gamma correction circuit 1112-3, and a rendering circuit 1112-4, or the like. The data conversion circuit 1112-2 receives image data from the controller 1112-1 and compensates the image data to display the image at the desired luminance according to the characteristics of the electronic device 1000 or the user's settings, or may convert the image data to reduce power consumption or compensate for afterimages.

The gamma correction circuit 1112-3 may convert the image data, gamma reference voltage, or the like in a way such that the image displayed on the electronic device 1000 has the desired gamma characteristics. The rendering circuit 1112-4 may receive image data from the controller 1112-1 and render the image data considering the pixel arrangement of the display panel 1141 applied to the electronic device 1000. At least one selected from the data conversion circuit 1112-2, the gamma correction circuit 1112-3, and the rendering circuit 1112-4 may be integrated into another component (for example, the main processor 1111 or the controller 1112-1). At least one selected from the data conversion circuit 1112-2, the gamma correction circuit 1112-3, and the rendering circuit 1112-4 may also be integrated into a source driver 1143 described later.

The memory 1120 may store various data used by at least one component of the electronic device 1000 (for example, the processor 1110 or the sensor module 1161), as well as input or output data for instructions related thereto. The memory 1120 may include at least one of volatile memory 1121 and non-volatile memory 1122.

The input module 1130 may receive instructions or data to be used by the components of the electronic device 1000 (for example, the processor 1110, sensor module 1161, or sound output module 1163) from an external source (for example, the user or an external electronic device 2000).

The input module 1130 may include a first input module 1131, where instructions or data are input from the user, and a second input module 1132, where instructions or data are input from an external electronic device 2000. The first input module 1131 may include a microphone, mouse, keyboard, key (for example, button), or pen (for example, passive pen or active pen). The second input module 1132 may support specified protocols for wired or wireless connections with the external electronic device 2000. In an embodiment, the second input module 1132 may include an high-definition multimedia interface (HDMI), universal serial bus (USB) interface, secure digital (SD) card interface, or audio interface. The second input module 1132 may include connectors for physically connecting to the external electronic device 2000, such as an HDMI connector, USB connector, SD card connector, or audio connector (for example, headphone connector).

The display module 1140 provides visual information to the user. The display module 1140 may include a display panel 1141, a gate driver 1142, a source driver 1143, and a light-emission driver 1144. The gate driver 1142 may correspond to at least a part of the scan driver 120 shown in FIG. 1. The source driver 1143 may correspond to at least a part of the data driver 130 shown in FIG. 1. The display module 1140 may further include a window, chassis, or bracket to protect the display panel 1141.

The display panel 1141 (or display) may include a liquid crystal display panel, organic light-emitting display panel, or inorganic light-emitting display panel, and the type of display panel 1141 is not particularly limited. The display panel 1141 may be a rigid type, or a flexible type capable of rolling or folding. The display module 1140 may further include a supporter, bracket, or heat dissipation member for supporting the display panel 1141.

The gate driver 1142, as a driving chip, may be mounted on the display panel 1141. Additionally, the gate driver 1142 may be integrated into the display panel 1141. In an embodiment, for example, the gate driver 1142 may include an amorphous silicon TFT gate driver circuit (ASG), low temperature polycrystalline silicon TFT gate driver circuit (LTPS), or oxide semiconductor TFT gate driver circuit (OSG) embedded within the display panel 1141. The light-emission driver 1144, as a driving chip, may be mounted on the display

panel 1141. Similarly to the gate driver 1142, the light-emission driver 1144 may also be integrated into the display panel 1141. The light-emission driver 1144 may be formed separately from the gate driver 1142 or may be integrated with the gate driver 1142. Additionally, the light-emission driver 1144 may generate a light-emission control signal in response to the light-emission start signal supplied from the start signal controller 516.

The source driver 1143 may be integrated into other components (for example, the controller 1112-1). The functions of the interface conversion circuit and the timing control circuit of the aforementioned controller 1112-1 may also be integrated into the source driver 1143.

The display module 1140 may further include a voltage generation circuit. This voltage generation circuit may output various voltages required for driving the display panel 1141. In an embodiment, the display panel 1141 may include a plurality of pixel rows, each including a plurality of pixels.

In another embodiment, the source driver 1143 may convert the data corresponding to red (R), green (G), and blue (B) included in the image data received from the processor 1110 (for example, output data) into red data signals (or data voltages), green data signals, and blue data signals, and provide them to the plurality of pixel rows included in the display panel 1141 during one horizontal period.

The power module 1150 supplies power voltage to the components of the electronic device 1000. The power module 1150 may include a battery that charges the power voltage. The battery may be a non-rechargeable primary cell, a rechargeable secondary cell, or a fuel cell. The power module 1150 may include a power management integrated circuit (PMIC). The PMIC supplies power optimized for each of the aforementioned and forthcoming modules. The power module 1150 may include a wireless power transmission and reception member electrically connected to the battery. The wireless power transmission and reception member may include a plurality of coil-shaped antenna radiators. The power module 1150 may be implemented to include the power supply 150 of FIG. 1.

The electronic device 1000 may further include an internal module 1160 and an external module 1170. The internal module 1160 may include a sensor module 1161, an antenna module 1162, and a sound output module 1163. The external module 1170 may include a camera module 1171, a light module 1172, and a communication module 1173.

The sensor module 1161 may detect inputs from the user's body or inputs by a pen of the first input module 1131 and may generate electrical signals or data values corresponding to the input. Additionally, the sensor module 1161 may detect external environmental factors (for example, illuminance, temperature, or the like) and generate electrical signals or data values corresponding to the external environment.

The sensor module 1161 may include at least one selected from a fingerprint sensor 1161-1, a photo sensor 1161-2, and an input sensor 1161-3. The fingerprint sensor 1161-1 may generate data values corresponding to the user's fingerprint. The fingerprint 1161-1 may include an optical or capacitive fingerprint sensor.

The photo sensor 1161-2 (or illuminance sensor) may detect external illuminance, and provide electrical signals or data values corresponding to the detected illuminance to the auxiliary processor 1112 (or processor 1110). Additionally, the photo sensor 1161-2 may provide a photo sensing signal PS to the controller 1112-1 when the illuminance is sensed. Upon receiving the photo sensing signal PS, the controller 1112-1 may control the number of off periods included in the light-emission start signal. In an embodiment, for example, the controller 1112-1 may control the light-emission start signal to include fewer off periods of the light-emission control signal in one frame period of the second driving frequency when the photo sensing signal PS is received.

The input sensor 1161-3 may generate data values corresponding to coordinate information of inputs by the user's body or pen. The input sensor 1161-3 generates as a data value a change in capacitance caused by the input. The input sensor 1161-3 may detect input by a passive pen, or transmit and receive data with an active pen.

The input sensor 1161-3 may also measure biometric signals such as blood pressure, moisture, or body fat. For instance, when the user touches a part of their body to the sensor layer or sensing panel and remains still for a certain period of time, the input sensor 1161-3 may detect biometric signals based on changes in the electric field caused by the body part and output the information desired by the user to the display module 1140.

The sensor module 1161 may further include a digitizer. The digitizer may generate data values corresponding to the coordinate information of inputs by a pen. The digitizer generates as a data value a change in electromagnetic field caused by the input. The digitizer may detect input by a passive pen or transmit and receive data with an active pen.

At least one selected from the fingerprint sensor 1161-1, the photo sensor 1161-2, and the input sensor 1161-3 may be implemented as a sensor layer formed on the display panel 1141 through a continuous process.

Additionally, at least two selected from the fingerprint sensor 1161-1, the photo sensor 1161-2, and the input sensor 1161-3 may be formed as an integrated sensing panel through a same process. When integrated into a single sensing panel, the sensing panel may be placed between the display panel 1141 and the window positioned above the display panel 1141. In an embodiment, the sensing panel may be placed on the window, and the location of the sensing panel is not particularly limited.

At least one selected from the fingerprint sensor 1161-1, the photo sensor 1161-2, and the input sensor 1161-3 may be embedded in the display panel 1141. That is, the at least one of the fingerprint sensor 1161-1, the photo sensor 1161-2, and the input sensor 1161-3 may be formed simultaneously by the process of forming the elements (for example, light-emitting elements, transistors, and the like) included in the display panel 1141.

Additionally, the sensor module 1161 may generate electrical signals or data values corresponding to the internal or external state of the electronic device 1000. The sensor module 1161 may further include, for example, a gesture sensor, gyro sensor, barometric sensor, magnetic sensor, accelerometer, grip sensor, proximity sensor, color sensor, infrared (IR) sensor, biometric sensor, temperature sensor, or humidity sensor.

The antenna module 1162 may include one or more antennas for transmitting or receiving signals or power to and from external sources. In an embodiment, the communication module 1173 may transmit signals to or receive signals from external electronic devices through an antenna suitable for the communication method. The antenna pattern of the antenna module 1162 may be integrated into one component of the display module 1140 (for example, the display panel 1141), the input sensor 1161-3, or the like.

The sound output module 1163 is a device for outputting sound signals externally from the electronic device 1000, and may include a speaker for general purposes such as multimedia playback or playing recordings, and a receiver used exclusively for receiving telephone calls. In an embodiment, the receiver may be formed integrally with or separately from the speaker. The sound output pattern of the sound output module 1163 may also be integrated into the display module 1140.

The camera module 1171 may capture still images and video. In an embodiment, the camera module 1171 may include one or more lenses, an image sensor, or an image signal processor. The camera module 1171 may further include an infrared camera capable of detecting the presence of a user, the location of a user, the gaze of a user, and the like.

The light module 1172 may provide light. The light module 1172 may include a light-emitting diode (LED) or a xenon lamp. The light module 1172 may operate in conjunction with the camera module 1171 or operate independently.

The communication module 1173 may support the establishment of wired or wireless communication channels between the electronic device 1000 and an external electronic device 2000 and performance of communication through the established communication channels. The communication module 1173 may include any one or both of a wireless communication module such as a cellular communication module, a short-range wireless communication module, or a global navigation satellite system (GNSS) communication module, as well as a wired communication module such as a local area network (LAN) communication module or a power line communication module. The communication module 1173 may communicate with external electronic devices 2000 through short-range communication networks such as Bluetooth, WiFi direct, or infrared data association (IrDA) or through long-range communication networks like cellular networks, the Internet, or computer networks (for example, LAN or WAN). The various types of communication modules 1173 described above may be implemented on a single chip or as separate chips.

The input module 1130, sensor module 1161, camera module 1171, and others may work in conjunction with the processor 1110 to control the operation of the display module 1140.

The processor 1110, based on input data received from the input module 1130, may output instructions or data to the display module 1140, the sound output module 1163, the camera module 1171, or the light module 1172. In an embodiment, for example, the processor 1110 may generate image data in response to input data provided via a mouse, an active pen, or the like and output it to the display module 1140, or may generate instruction data in response to input data and output it to the camera module 1171 or the light module 1172. When no input data is received from the input module 1130 for a certain period, the processor 1110 may switch the operation mode of the electronic device 1000 to a low-power mode or sleep mode to reduce power consumption consumed by the electronic device 1000.

The processor 1110, based on sensing data received from the sensor module 1161, outputs instructions or data to the display module 1140, the sound output module 1163, the camera module 1171, or the light module 1172. For instance, the processor 1110 may compare authentication data provided by the fingerprint sensor 1161-1 with authentication data stored in memory 1120 and then execute an application based on the comparison result. The processor 1110 may execute instructions based on sensing data detected by the input sensor 1161-3 or output corresponding image data to the display module 1140. The processor 1110 may control the illuminance of the display panel 1141 based on the illuminance detected by the photo sensor 1161-2. In an embodiment where the sensor module 1161 includes a temperature sensor, the processor 1110 may receive temperature data about a measured temperature from the sensor module 1161, and may further perform luminance correction of the image data based on the temperature data, etc.

The processor 1110 may receive measurement data from the camera module 1171 about the presence of a user, the location of the user, the gaze of the user, and the like. Based on this measurement data, the processor 1110 may further perform luminance correction on the image data. In an embodiment, for example, after determining the presence of the user through input from the camera module 1171, the processor 1110 may output luminance-corrected image data to the display module 1140 via the data conversion circuit 1112-2 or the gamma correction circuit 1112-3.

Some of the above components may be interconnected through communication methods between peripheral devices, such as buses, general purpose input/output (GPIO), serial peripheral interface (SPI), mobile industry processor interface (MIPI), or ultra path interconnect (UPI) links, to exchange signals (for example, instructions or data) with each other. The processor 1110 may communicate with the display module 1140 through a predefined interface, for example, using any one of the aforementioned communication methods, but it is not limited to these communication methods.

The electronic device 1000 according to various embodiments disclosed herein may be in various forms. The electronic device 1000 may include, for example, a portable communication device (for example, a smartphone), a computing device, a portable multimedia device, a portable medical device, a camera, a wearable device, or a home appliance. The electronic device 1000 according to embodiments herein is not limited to the aforementioned devices.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A pixel comprising:
a driving transistor including a gate electrode connected to a first node, and connected between a first power voltage and a second node;
a light-emitting element connected between the second node and a second power voltage;
a first switching transistor including a gate electrode connected to a scan line, and connected between a data line and the first node;
a second switching transistor including a gate electrode connected to a sensing scan line, and connected between a readout line, which supplies a third power voltage, and the second node; and
a third switching transistor including a gate electrode connected to an initialization scan line, and connected between an initialization line, which supplies a fourth power voltage, and the second node,
wherein the second switching transistor is turned on during a first period, and the third switching transistor is turned on during a second period different from the first period.

2. The pixel of claim 1, further comprising:
a storage capacitor connected between the first node and the second node.

3. The pixel of claim 2, wherein
a charging operation is performed during the first period to set a gate-source voltage of the driving transistor, and
an initialization operation is performed during the second period to initialize a voltage of the second node.

4. The pixel of claim 3, wherein
during the first period, while the second switching transistor is turned on, the third switching transistor is turned off, and
during the second period, while the third switching transistor is turned on, the second switching transistor is turned off.

5. The pixel of claim 4, wherein
during the charging operation, the first switching transistor is turned on.

6. The pixel of claim 4, wherein
during the initialization operation, the first switching transistor is turned off.

7. The pixel of claim 1, wherein
a magnitude of the third power voltage is the same as a magnitude of the fourth power voltage.

8. A display device comprising:
a display panel including a plurality of pixels;
a scan driver connected to the display panel through a plurality of scan lines, a plurality of sensing scan lines, and a plurality of initialization scan lines;
a data driver connected to the display panel through a plurality of data lines, a plurality of readout lines, and a plurality of initialization lines; and
a timing controller which receives image data, and controls the scan driver and the data driver to display an image corresponding to the image data,
wherein each of the plurality of pixels includes:
a driving transistor including a gate electrode connected to a first node therein, and connected between a first power voltage and a second node therein;
a light-emitting element connected between the second node and a second power voltage;
a first switching transistor including a gate electrode connected to a corresponding one of the plurality of scan lines, and connected between a corresponding one of the plurality of data lines and the first node therein;
a second switching transistor including a gate electrode connected to a corresponding one of the plurality of sensing scan lines, and connected between a corresponding one of the plurality of readout lines, which supplies a third power voltage, and the second node therein; and
a third switching transistor including a gate electrode connected to a corresponding one of the plurality of initialization scan lines, and connected between a corresponding one of the plurality of initialization lines, which supplies a fourth power voltage, and the second node,
wherein the second switching transistor is turned on during a first period, and the third switching transistor is turned on during a second period different from the first period.

9. The display device of claim 8,
wherein each of the plurality of pixels further includes:
a storage capacitor connected between the first node therein and the second node therein.

10. The display device of claim 9, wherein
during the first period, a charging operation for a pixel is performed to set a gate-source voltage of the driving transistor of the pixel, and
during the second period, an initialization operation for the pixel is performed to initialize a voltage of the second node in the pixel.

11. The display device of claim 10, wherein
during the first period, while the second switching transistor included in a pixel is turned on, the third switching transistor included in the pixel is turned off, and
during the second period, while the third switching transistor included in the pixel is turned on, the second switching transistor included in the pixel is turned off.

12. The display device of claim 10, wherein
during the charging operation for the pixel, the first switching transistor of the pixel is turned on.

13. The display device of claim 10, wherein:
during the initialization operation for the pixel, the first switching transistor of the pixel is turned off.

14. The display device of claim 8, wherein:
a magnitude of the third power voltage is equal to a magnitude of the fourth power voltage.

15. The display device of claim 8, wherein:
a first pixel among the plurality of pixels is connected to a first scan line among the plurality of scan lines, a first data line among the plurality of data lines, a first readout line among the plurality of readout lines, and a first initialization line among the plurality of initialization lines,
a second pixel among the plurality of pixels is connected to a second scan line among the plurality of scan lines, the first data line, the first readout line, and the first initialization line, and
during a charging operation of the first pixel, an initialization operation of the second pixel is performed.

16. The display device of claim 15, wherein:
during an application of the third power voltage to the first pixel through the first readout line, the fourth power voltage is applied to the second pixel through the first initialization line.

17. An electronic device comprising:
a display panel including a plurality of pixels;
a gate driver connected to the display panel through a plurality of scan lines, a plurality of sensing scan lines, and a plurality of initialization scan lines;
a source driver connected to the display panel through a plurality of data lines, a plurality of readout lines, and a plurality of initialization lines; and
a controller which controls the gate driver and the source driver to display an image on the display panel,
wherein each of the plurality of pixels includes:
a driving transistor including a gate electrode connected to a first node, and connected between a first power voltage and a second node;
a light-emitting element connected between the second node and a second power voltage;
a first switching transistor including a gate electrode connected to a corresponding one of the plurality of scan lines, and connected between a corresponding one of the plurality of data lines and the first node;
a storage capacitor connected between the first node and the second node;
a second switching transistor including a gate electrode connected to a corresponding one of the plurality of sensing scan lines, and connected between the second node and a corresponding one of the plurality of readout lines, which supplies a third power voltage; and
a third switching transistor including a gate electrode connected to a corresponding one of the plurality of initialization scan lines, and connected between the second node and a corresponding one of the plurality of initialization lines, which supplies a fourth power voltage,
wherein the second switching transistor is turned on during a first period, and the third switching transistor is turned on during a second period different from the first period.

18. The electronic device of claim 17, wherein
during the first period, a charging operation for a pixel is performed to set a gate-source voltage of the driving transistor of the pixel, and
during the second period, an initialization operation for the pixel is performed to initialize a voltage of the second node in the pixel.

19. The electronic device of claim 18, wherein
a first pixel of the plurality of pixels is connected to a first scan line among the plurality of scan lines, a first data line among the plurality of data lines, a first readout line among the plurality of readout lines, and a first initialization line among the plurality of initialization lines, and
a second pixel of the plurality of pixels is connected to a second scan line among the plurality of scan lines, the first data line, the first readout line, and the first initialization line,
wherein during a charging operation of the first pixel, an initialization operation is performed on the second pixel.

20. The electronic device of claim 19, wherein
while the third power voltage is applied to the first pixel through the first readout line, the fourth power voltage is applied to the second pixel through the first initialization line.
